(19) United States
(12) Patent Application Publication
(10) Pub. No.: US 2026/0003926 A1
(43) Pub. Date: Jan. 1, 2026

(54) SPREADSHEET DEVICE, SPREADSHEET METHOD, SPREADSHEET PROGRAM, AND ADD-IN PROGRAM

(71) Applicant: BUSYBEE INC., Tokyo (JP)

(72) Inventors: Kappei NAKANO, Tokyo (JP); Manh Dinh NGUYEN, Hanoi City (VN)

(21) Appl. No.: 18/873,935

(22) PCT Filed: Jan. 25, 2024
(86) PCT No.: PCT/JP2024/002148

§ 371 Date: Dec. 11, 2024

(51) Int. Cl. G06F 16/957; G06F 40/18

(52) U.S. Cl. CPC G06F 16/957; G06F 40/18

(57) ABSTRACT

In a case where query information is stored in a cache sheet when recalculation is performed on a cell, a spreadsheet device (100) acquires an answer stored in the cache sheet in association with the query information, as a value to be stored in the cell in place of transmitting a query to an external server and acquiring an answer.

### TECHNICAL FIELD

The present disclosure relates to a spreadsheet device, a spreadsheet method, a spreadsheet program, and an add-in program.

### BACKGROUND ART

Conventionally, devices that perform spreadsheet calculation have been known (for example, Patent Literature 1).

### CITATION LIST

### Patent Literature

Patent Literature 1: Unexamined Japanese Patent Application Publication No. H08-235266

### SUMMARY OF INVENTION

### Technical Problem

However, in a device disclosed in Patent Literature 1, when a mathematical expression that uses a value obtained by transmitting a query to a server is set in a cell included in a spreadsheet, a query to the server is performed every time recalculation of the cell is performed. Therefore, there has been a problem in that the device disclosed in Patent Literature 1 cannot suppress an increase in a communication volume.

The present disclosure has been made in consideration of the above-described problem, and an objective of the present disclosure is to provide a spreadsheet device, a spreadsheet method, a spreadsheet program, and an add-in program capable of suppressing an increase in a communication volume.

### Solution to Problem

In order to achieve the above-described objective, a spreadsheet device according to a first aspect of the present disclosure is a spreadsheet device to process a worksheet and a cache sheet, the spreadsheet device characterized by performing a process comprising:
(1) in a case where in a cell in the worksheet, a mathematical expression that calls a query function referring to an input value having been input to another cell in the worksheet is set:
   (a) generating a query that is based on the input value;
   (b) transmitting the query to an external server;
   (c) acquiring an answer from the external server;
   (d) storing query information representing the query and the answer in the cache sheet in association with each other; and
   (e) storing the acquired answer as a value of the cell; and
(2) in a case where the query information representing the query is stored in the cache sheet when recalculation is performed on the cell,
   acquiring the answer that is stored in the cache sheet in association with the query information, as a value to be stored in the cell in place of transmitting the query to the external server and acquiring the answer.

In addition, in order to achieve the above-described objective, an add-in program according to a second aspect of the present disclosure is
an add-in program characterized by causing a computer of a spreadsheet device including a communicator and configured to execute a spreadsheet program to function as an inquirer, the inquirer performing a process comprising
in a case of a saved state in which a query based on a query argument acquired from the spreadsheet program or query information representing the query and an answer from a server to the query are saved in a spreadsheet in association with each other:
(1) preventing causing the communicator to transmit the query to the server;
(2) acquiring the answer associated with the query or the query information from the spreadsheet; and
(3) outputting the acquired answer as a return value to the spreadsheet program.

### Advantageous Effects of Invention

The spreadsheet device, the spreadsheet method, the spreadsheet program, and the add-in program according to the present disclosure enable an increase in a communication volume to be suppressed.

### BRIEF DESCRIPTION OF DRAWINGS

FIG. 1 is a system configuration diagram illustrating a configuration example of a spreadsheet system according to an embodiment of the present disclosure;

FIG. 2 is a hardware configuration diagram illustrating a configuration example of a spreadsheet device;

FIG. 3 is a functional block diagram illustrating an example of functions that the spreadsheet device includes;

FIG. 4 is a diagram illustrating an example of a worksheet that the spreadsheet device processes;

FIG. 5 is a diagram illustrating an example of a cache sheet that the spreadsheet device according to the embodiment processes;

FIG. 6 is a flowchart illustrating an example of spreadsheet processing that the spreadsheet device performs;

FIG. 7 is a flowchart illustrating an example of query processing that the spreadsheet device according to the embodiment performs;

FIG. 8 is a diagram illustrating an example of a cache sheet that a spreadsheet device according to Modified Example 7 of the embodiment processes; and

FIG. 9 is a flowchart illustrating an example of query processing that a spreadsheet device according to Modified Example 9 of the embodiment performs.

### DESCRIPTION OF EMBODIMENTS

### Embodiment

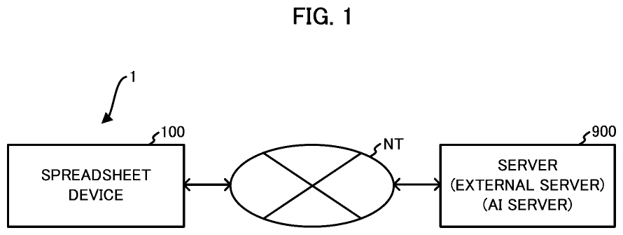

An embodiment of the present disclosure is described below in detail with reference to the drawings. A spreadsheet system 1 according to the embodiment of the present disclosure includes a spreadsheet device 100 as illustrated in FIG. 1 that executes a spreadsheet program to which an add-in program is added. Although in the present embodiment, the following description is made assuming that the spreadsheet program is Excel, the present disclosure is not limited to the configuration.

The spreadsheet device 100 is connected to a server 900 via a network NT that is, for example, the Internet, a local area network (LAN), or a wide area network (WAN). Since the server 900 is not included in the spreadsheet system 1 and is located outside the spreadsheet system 1, the server 900 is also referred to as an external server. The server 900 is equipped with an interactive generative artificial intelligence (AI), such as chat generative pre-trained transformer (ChatGPT). When the server 900 receives a query from the spreadsheet device 100, the server 900 generates an answer to the received query, using the generative AI and returns the generated answer to the spreadsheet device 100. Therefore, the server 900 is also referred to as an AI server.

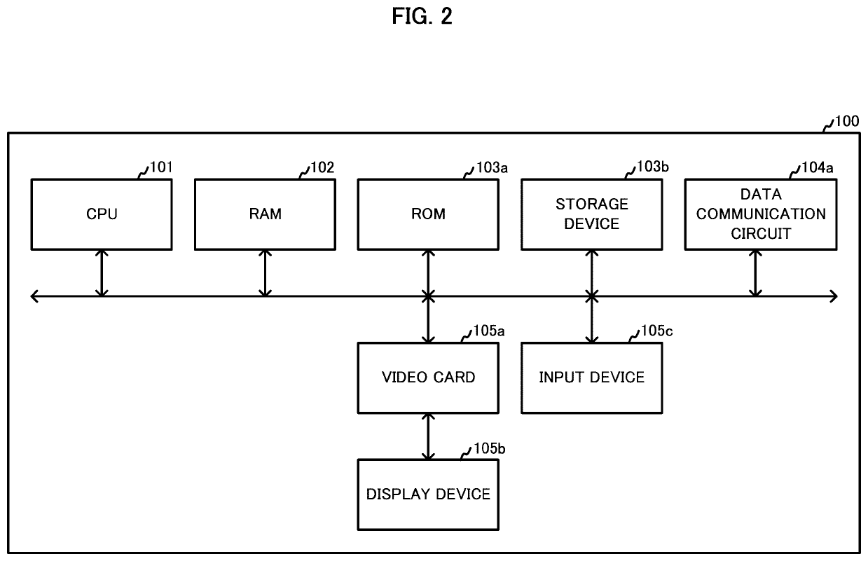

The spreadsheet device 100 includes one or a plurality of central processing units (CPUs) 101, random access memories (RAMs) 102, read only memories (ROMs) 103a, storage devices 103b, data communication circuits 104a, video cards 105a, display devices 105b, and input devices 105c, as illustrated in FIG. 2. The CPU 101 executes a program stored in the ROM 103a or the storage device 103b. The RAM 102 temporarily stores data to be processed, at the time of execution of a program. The storage device 103b is, for example, a flash memory that is a semiconductor memory or a hard disk and stores various types of data.

The data communication circuit 104a of the spreadsheet device 100 performs data communication with a not-illustrated base station, using radio waves in accordance with a communication standard, such as long term evolution (LTE) and 5th generation (5G), when the network NT is the Internet. Through this data communication, the data communication circuit 104a performs data communication with the server 900 via the network NT connected to the base station. In contrast, when the network NT is a LAN or a WAN, the data communication circuit 104a performs communication with a not-illustrated access point connected to the network NT, using a radio waves in accordance with a communication standard, such as “11ac”.

The video card 105a of the spreadsheet device 100 outputs an image signal, based on a signal output from the CPU 101. The display device 105b is, for example, a liquid crystal display (LCD), a plasma display panel (PDP), or an electroluminescence (EL) display and displays an image in accordance with an image signal output from the video card 105a. The input device 105c is, for example, at least one of a keyboard, a mouse, or a touch pad and inputs a signal matching an operation by a user.

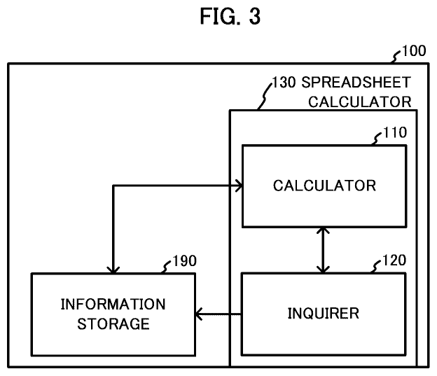

When the user performs an operation to start execution of the spreadsheet program on the input device 105c of the spreadsheet device 100, the input device 105c outputs a signal matching the operation. When the signal is output from the input device 105c, the CPU 101 executes the spreadsheet program stored in the storage device 103b. In the present embodiment, since an add-in program is added to the spreadsheet program, the CPU 101 functions as a spreadsheet calculator 130 as illustrated in FIG. 3 by executing both the spreadsheet program itself and the add-in program.

The spreadsheet calculator 130 includes a calculator 110 that is achieved by the CPU 101 executing the spreadsheet program itself and an inquirer 120 that is achieved by the CPU 101 executing the add-in program. In addition, the storage device 103b functions as an information storage 190.

Next, when an operation to select an electronic file that is stored in the information storage 190 in advance and open a workbook (simply referred to as a book) that is represented by the selected electronic file is performed on the input device 105c, the CPU 101 retrieves the selected electronic file. Next, the CPU 101 opens a book represented by the retrieved electronic file and causes the display device 105b to display the opened book.

Although in the present embodiment, for simplification of description, the following description is made using, as a specific example, a case where an existing book that includes one table calculation form (referred to as a spreadsheet) in advance is opened, a new book may be generated. The spreadsheet includes a plurality of rows and a plurality of columns, and each row includes a plurality of cells that is arranged in line in a scan direction and each column includes a plurality of cells that is arranged in line in a sub-scan direction. In the present embodiment, the following description is made using, as a specific example, a case where the one spreadsheet that the existing book to be opened includes is a worksheet and not a cache sheet.

The worksheet is a spreadsheet in which input of a value or setting of a mathematical expression is performed on a cell in accordance with an operation by the user, and the cache sheet is a spreadsheet in which a value to be used in calculation of a mathematical expression set in a cell in the worksheet is input to a cell. Hereinafter, for simplification of description, inputting a value to a cell and setting a mathematical expression in a cell are collectively referred to as editing a cell. In addition, a cell in a worksheet is referred to as a work cell, and a cell in a cache sheet is referred to as a cache cell.

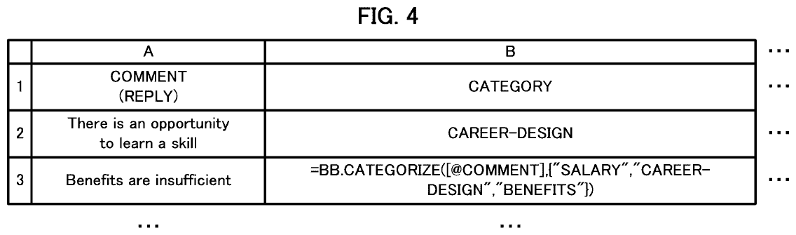

In the present embodiment, the following description is made using, as a specific example, a case where in a cell at the second row and the A-th column in one worksheet that the existing book includes, a character string “There is an opportunity to learn a skill” that represents a reply to a questionnaire as illustrated in FIG. 4 is input in advance. In addition, in the present embodiment, the following description is made using, as a specific example, a case where after the existing book is opened, a mathematical expression that calls a query function referring to a value having been input (referred to as an input value) to the cell at the second row and the A-th column (referred to as a work cell 2A) in the worksheet is set in a cell at the second row and the B-th column (referred to as a work cell 2B) included in the same worksheet by the user. The mathematical expression that calls a query function means a mathematical expression that includes the query function, and the query function means a function (1) to which an argument (referred to as a query argument) is passed and (2) that returns, as a return value, an answer from the server 900 to a query, the answer being generated based on the query argument.

In the present embodiment, the query function is a function that (1) takes, as query arguments, (a) an input value to be referred to and (b) a character string that (i) is a character string included in the mathematical expression and (ii) represents a plurality of categories and (2) returns, as a return value, an answer from the server 900 to a query querying a categorization destination into which the input value is categorized among the plurality of categories. In addition, in the present embodiment, the following description is made using, as a specific example, a case where the plurality of categories includes “salary”, “career-design”, and “benefits”. Because of this configuration, the query function called by the mathematical expression in the work cell 2B returns, as a return value, an answer representing a category that the server 900 replied as a categorization destination into which a reply to the questionnaire represented by the input value in the work cell 2A is categorized among the categories “salary”, “career-design”, and “benefits”.

When after the book is opened in accordance with an operation by the user, an operation to input a mathematical expression to the work cell 2B is performed on the input device 105c of the spreadsheet device 100 by the user, the input device 105c outputs a signal matching the operation. When the signal is output, the CPU 101 edits the work cell 2B in accordance with the operation. Subsequently, the CPU 101 acquires, from, for example, an event handler, information representing an event that has occurred. Next, when the CPU 101 determines that an event represented by the acquired information (referred to as an acquired event) is an event in which a cell is edited (referred to as an edit event), the CPU 101 performs calculation of the cell included in the book. Performing calculation of a cell means to calculate a mathematical expression set in the cell. In addition, calculating a mathematical expression set in a cell includes a first calculation and second and subsequent calculations (referred to as recalculation) as counted from the time at which the mathematical expression is set in the cell or as counted from the time at which the mathematical expression set in the cell is changed.

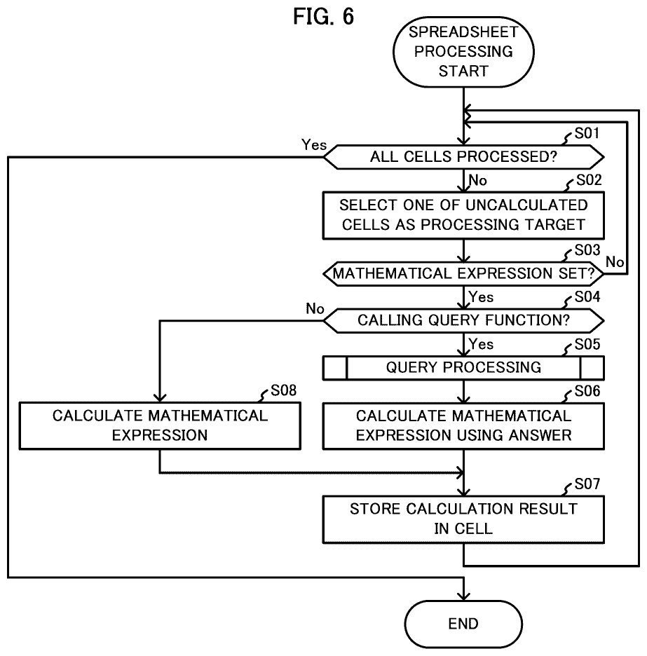

For this purpose, the CPU 101 of the spreadsheet device 100 performs spreadsheet processing, as illustrated in FIG. 6, the processing details of which are described in the spreadsheet program itself. When performance of the spreadsheet processing is started, the calculator 110 determines whether or not succeeding processing including step S03 described below has been performed with respect to all cells in all spreadsheets included in the book (step S01). On this occasion, the calculator 110 determines that the processing has not been performed with respect to all the cells (step S01; No) and selects, as a processing target, one of cells that have not been subjected to the processing (step S02). In the present embodiment, the following description is made using, as a specific example, a case where the work cell 2A is first selected as a processing target.

Next, the calculator 110 in the spreadsheet device 100 determines that in the work cell 2A, which is a processing target, a character string representing a reply to a questionnaire is input and no mathematical expression is set (step S03; No) and repeats the above-described processing from step S01. Next, the calculator 110 performs the processing in steps S01 and S02 again and thereby selects, as a processing target, one of cells different from the work cell 2A among the plurality of cells included in the book, which has already been selected as a processing target. In the present embodiment, the following description is made using, as a specific example, a case where the work cell 2B is selected as a processing target.

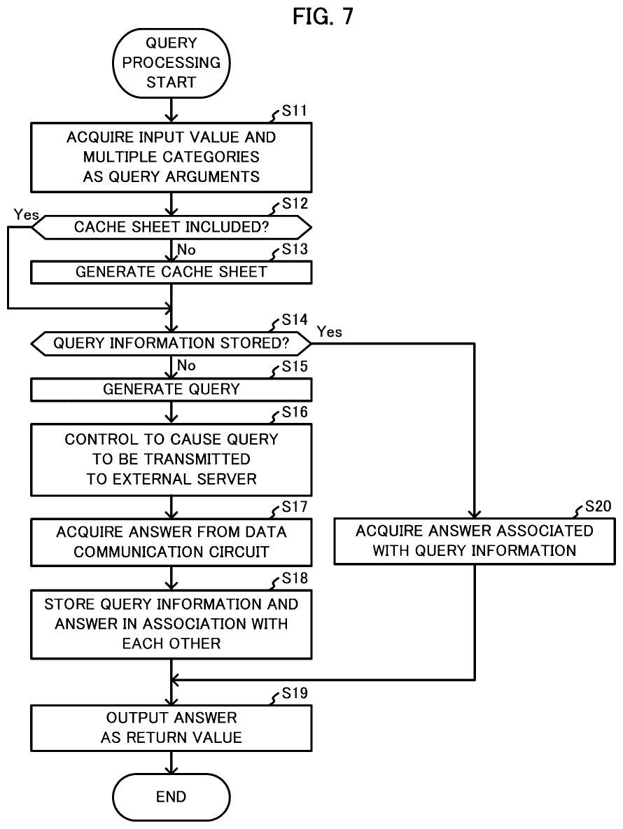

After step S02 is performed, the calculator 110 in the spreadsheet device 100 determines that a mathematical expression is set in the work cell 2B that is selected as a processing target (step S03; Yes). Next, the calculator 110 determines that the mathematical expression in the work cell 2B calls a query function (step S04; Yes). Subsequently, the CPU 101 that functions as the calculator 110 retrieves, from the information storage 190, an add-in program for the spreadsheet program that is associated in advance with information representing a name of the query function, from among one or a plurality of add-in programs added to the spreadsheet program. Next, the CPU 101 executes the retrieved add-in program and thereby performs query processing as illustrated in FIG. 7 (step S05). Through this processing, the CPU 101 functions as the inquirer 120 as illustrated in FIG. 3.

When performance of the query processing is started, the inquirer 120 in the spreadsheet device 100 acquires (1) the input value in the work cell 2A that the work cell 2B refers to and (2) the character string representing the plurality of categories included in the mathematical expression in the work cell 2B, from the spreadsheet program itself as query arguments (step S11).

Next, the inquirer 120 in the spreadsheet device 100 determines whether or not the book includes a cache sheet. Although in the present embodiment, a predetermined character string indicating that the sheet is a cache sheet (referred to as a cache name character string) is included in a name of the cache sheet, no cache name character string is included in a name of a worksheet. Thus, the inquirer 120 first acquires a cache name character string from, for example, binary data representing the add-in program. Next, the inquirer 120 acquires names of all the spreadsheets included in the book and determines whether or not the book includes a cache sheet by determining whether or not a name including the cache name character string exists among the acquired names. Since in the present embodiment, no name including the cache name character string exists, the inquirer 120 determines that the book does not include a cache sheet (step S12; No).

Subsequently, the inquirer 120 in the spreadsheet device 100 generates a new cache sheet in the book (step S13). In the present embodiment, the following description is made using, as a specific example, a case where no value has been input and no mathematical expression has been set in cells in the new cache sheet.

After the inquirer 120 in the spreadsheet device 100 generates a cache sheet, the inquirer 120 determines whether or not information representing a query (referred to as query information) generated based on a query argument is stored in the generated cache sheet (step S14). Query information being stored in the cache sheet means that the query information is saved in the cache sheet, and the query information being saved in the cache sheet means that the query information is input to a cell included in the cache sheet as a value.

In the present embodiment, a query is data (1) to be transmitted to the server 900 and (2) including (a) information representing a uniform resource locator (URL) of the server 900 and (b) text data. In the present embodiment, the following description is made using, as a specific example, a case where the text data are data representing a text that is structured (referred to as a structured text) in accordance with, for example, a data format conforming to JavaScript object notation (JSON). However, a text represented by the text data may be an unstructured text or a text structured in accordance with a format other than the format conforming to JSON.

A text represented by the text data includes a character string that (1) is a character string generated based on a query argument and (2) represents a query content to the server 900. In this example, the query arguments are the input value “There is an opportunity to learn a skill” in the work cell 2A and a character string representing the plurality of categories “salary”, “career-design”, and “benefits”. Thus, in the present embodiment, the following description is made using, as a specific example, a case where a character string representing the query content generated based on the query arguments includes a character string representing a question “Into which one of ‘salary’, ‘career-design’, and ‘benefits’ is the reply ‘There is an opportunity to learn a skill’ categorized?”. In addition, in the present embodiment, the following description is made using, as a specific example, a case where information representing a query is information for identifying the query and the information for identifying the query is a hash value of text data included in the query. However, the query information is not limited to a hash value, and any type of information can be used as long as the information is information for identifying the query.

In step S14, the inquirer 120 in the spreadsheet device 100 generates a structured text including a character string representing a query content to the server 900, based on (1) the input value in the work cell 2A and (2) the character string representing the plurality of categories, which are acquired as query arguments. Next, the inquirer 120 generates query information by calculating a hash value of the generated structured text. Subsequently, the inquirer 120 attempts to acquire the generated query information from the cache sheet by searching the cache sheet, based on the generated query information. Next, the inquirer 120 determines that the query information is not stored in the cache sheet since the inquirer 120 cannot acquire the query information (step S14; No).

Next, the inquirer 120 in the spreadsheet device 100 acquires information representing the URL of the server 900 from, for example, the binary data representing the add-in program. Subsequently, the inquirer 120 generates a query including the acquired information representing the URL and the text data representing the generated structured text (step S15). Subsequently, the inquirer 120 outputs the generated query to the data communication circuit 104a in FIG. 2, and the data communication circuit 104a transmits the query to the server 900. In this way, the inquirer 120 performs control to cause the query to be transmitted to the server 900 on the data communication circuit 104a (step S16). Subsequently, when the data communication circuit 104a receives an answer to the query from the server 900, the inquirer 120 acquires the answer from the data communication circuit 104a (step S17). In the present embodiment, the following description is made using, as a specific example, a case where a character string representing the category “career-design” is acquired as an answer.

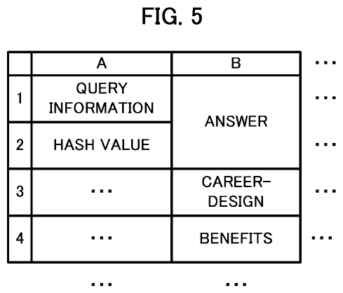

Subsequently, the inquirer 120 in the spreadsheet device 100 stores the query information and the answer “career-design” in the cache sheet in association with each other (step S18). For this purpose, the inquirer 120 inputs a hash value that is the query information in a cache cell at the third row and the A-th column illustrated in FIG. 5 as a value. In addition, the inquirer 120 inputs the answer “career-design” in a cache cell at the third row and the B-th column as a value. Subsequently, after the inquirer 120 in the spreadsheet device 100 outputs the answer “career-design” to the spreadsheet program itself as a return value of the query function (step S19), the inquirer 120 terminates the performance of the query processing.

After the query processing is performed in step S05 in FIG. 6, the calculator 110 in the spreadsheet device 100 acquires the answer “career-design” as a return value of the query function from the add-in program. Next, the calculator 110 calculates the mathematical expression set in the work cell 2B, using the acquired answer (step S06). Since in the present embodiment, a mathematical expression that outputs the return value of the query function as a calculation result is set in the work cell 2B, the calculator 110 stores the answer “career-design”, which is acquired as a return value, in the work cell 2B as a value of the work cell 2B (step S07). Storing the answer “career-design” in the cell as a value of the cell means to change or maintain a calculation result of the mathematical expression displayed in the cell to the character string “career-design” while maintaining the mathematical expression set in the cell. Since in the present embodiment, an answer output as a return value is stored in the work cell 2B as a value, outputting an answer as a return value is also referred to as outputting an answer as a value of a cell.

After the answer “career-design” is stored in the work cell 2B as a value, the calculator 110 in the spreadsheet device 100 returns to step S01 and repeats performance of the processing in steps S01 to S03. Through this processing, the calculator 110 successively selects a cell different from the work cells 2A and 2B among the plurality of cells included in the book as a processing target and determines that no mathematical expression is set in the processing target cell. The reason why the determination is made in such a manner is that in a cell different from the work cells 2A and 2B, (1) no value has been input and no mathematical expression has been set since the cell has not been edited yet or (2) although query information has been input as a value, no mathematical expression has been set. Subsequently, the calculator 110 determines that all the cells have been subjected to the processing (step S01; Yes) and terminates the performance of the spreadsheet processing.

Next, the following description is made using, as a specific example, a case where a character string “Benefits are insufficient” representing a reply to the questionnaire is input, as a value, in a work cell at the third row and the A-th column (referred to as a work cell 3A) illustrated in FIG. 4. When an operation to input a character string to the work cell 3A is performed, the CPU

101 edits the work cell 3A in accordance with the operation and performs the second performance of the spreadsheet processing illustrated in FIG. 6 as counted from the time at which the book is opened. Next, the calculator 110 in the spreadsheet device 100 selects the work cell 2A as a processing target and determines that no mathematical expression is set in the work cell 2A by performing the processing in steps S01 to S03. Subsequently, the calculator 110 returns to step S01 and selects the work cell 2B as a processing target and determines that a mathematical expression is set in the work cell 2B by performing the processing in steps S01 to S03 again (step S03; Yes). Next, the calculator 110 determines that the mathematical expression in the work cell 2B calls a query function by performing the processing in steps S04 and S05, and performs the second performance of the query processing illustrated in FIG. 7 as counted from the time at which the book is opened.

Subsequently, after the inquirer 120 in the spreadsheet device 100 performs the processing in step S11, the inquirer 120 determines that a name including the cache name character string exists among all the names of the spreadsheets included in the book. Thus, the inquirer 120 determines that the book includes a cache sheet (step S12; Yes). Next, the inquirer 120 determines whether or not query information is saved in the cache sheet without performing the processing in step S13 of generating a new cache sheet (step S14). On this occasion, the inquirer 120 attempts to acquire query information from the cache sheet and acquires the query information stored in the cache sheet at the time of the first performance of the query processing. Thus, the inquirer 120 determines that query information is stored in the cache sheet (step S14; Yes).

Next, the inquirer 120 in the spreadsheet device 100 acquires the answer “career-design” associated with the query information from the cache sheet without performing the processing in steps S15 to S18 (step S20). That is, the inquirer 120 acquires an answer from the cache sheet in place of generating a query, performing control to cause the query to be transmitted on the data communication circuit 104a, and acquiring an answer from the data communication circuit 104a. Subsequently, after the inquirer 120 outputs the answer “career-design” acquired from the cache sheet to the spreadsheet program as a return value of the query function (step S19), the inquirer 120 terminates the performance of the query processing.

After the query processing is performed for the second time in step S05 in FIG. 6, the calculator 110 in the spreadsheet device 100 stores the answer “career-design” acquired from the cache sheet in the work cell 2B as a value by performing the processing in steps S06 and S07. Since in the present embodiment, an answer acquired from the cache sheet is output as a return value and the answer output as a return value is stored in the work cell 2B as a value, acquiring an answer from the cache sheet is also referred to as acquiring an answer as a value to be stored in the work cell 2B.

After the answer is stored in the work cell 2B as a value, the calculator 110 in the spreadsheet device 100 returns to step S01 and repeats the processing in steps S01 to S03. Through this processing, the calculator 110 successively selects a cell different from the work cells 2A and 2B among the plurality of cells included in the book as a processing target and determines that no mathematical expression is set in the processing target cell. Subsequently, the calculator 110 determines that all the cells have been subjected to the processing (step S01; Yes) and terminates the performance of the spreadsheet processing.

Finally, the following description is made using, as a specific example, a case where an operation to instruct saving of the book is performed on the input device 105c of the spreadsheet device 100. When the input device 105c outputs a signal matching the operation, the calculator 110 in the spreadsheet device 100 rewrites the electronic file stored in the information storage 190 with an electronic file representing the book after edit. Through this processing, the calculator 110 saves the worksheet that is edited by the spreadsheet program and the cache sheet that is generated by the add-in program and in which the query information is stored, in the same electronic file.

According to the above-described configuration, when query information is stored in the cache sheet, the spreadsheet device 100 acquires the answer “career-design” stored in the cache sheet in association with the query information, as a value to be stored in the work cell 2B in place of transmitting a query to the server 900 and acquiring an answer. Therefore, the spreadsheet device 100 is capable of suppressing an increase in a communication volume. When a usage fee of the server 900 is determined according to at least one of a communication volume between the server 900 and the spreadsheet device 100 or the amount of calculation required for the server 900 to generate an answer, the spreadsheet device 100 is capable of suppressing an increase in the usage fee of the server 900.

In addition, since query information and an answer are stored in the cache sheet, a cache server operated by a third party can be made unnecessary. That is, necessity to save query information and an answer in a cache server operated by a third party can be eliminated. Therefore, payment of a usage fee of the cache server operated by the third party can be made unnecessary, which enables an increase in an operational cost of the spreadsheet device 100 to be suppressed.

In addition, since the spreadsheet device 100 can eliminate necessity to save query information and an answer in a cache server operated by a third party, leakage of information can be prevented. That is, it is possible to prevent, for example, a query content to the server 900 from being leaked from the cache server operated by the third party. Further, since a cache server operated by one's own company is made unnecessary, an operational cost of the spreadsheet device 100 can be suppressed from increasing. The one's own company includes, for example, a natural person or a corporation operating the spreadsheet system 1, although not limited thereto.

In addition, according to the above-described configuration, when no cache sheet exists in a book, the inquirer 120 in the spreadsheet device 100 generates a cache sheet in the book and stores query information and an answer in the generated cache sheet. Further, the calculator 110 in the spreadsheet device 100 saves each of a worksheet and a cache sheet in the same electronic file. Therefore, the user can easily compare query information and an answer stored in the cache sheet with values displayed in the worksheet.

### Modified Example 1 of Embodiment

Although in the embodiment, a case where a piece of query information is stored in the cache sheet is described, a plurality of pieces of query information may be stored in the cache sheet. In this case, the inquirer 120 may acquire one or a plurality of pieces of query information having already been stored in the cache sheet and subsequently sort one piece of query information to be newly stored in the cache sheet and the acquired one or a plurality of pieces of query information in accordance with a predetermined rule including ascending order or descending order. An algorithm used in the sort may be a known sort algorithm including, for example, quick sort. Subsequently, the inquirer 120 may, after deleting the one or plurality of pieces of query information having already been stored in the cache sheet, successively store the sorted plurality of pieces of query information in the cache sheet in accordance with a result of the sort. In addition, the inquirer 120 may search the plurality of pieces of query information stored in the cache sheet for a desired piece of query information, using a known search algorithm including a binary search. According to this configuration, the spreadsheet device 100 is capable of suppressing an increase in the amount of calculation required to search for a piece of query information.

### Modified Example 2 of Embodiment

In the embodiment, it is described that the query function takes an input value representing a reply to a questionnaire as a query argument. In the embodiment, it is also described that the query function is a function that returns, as a return value, an answer from the server 900 to a query querying into which one of a plurality of categories including “career-design” a reply represented by the query argument is categorized. However, the query function may be a function that takes an input value representing a reply to a questionnaire as a query argument and returns, as a return value, an answer from the server 900 to a query querying into which one of a plurality of categories “positive content”, “negative content”, and “neutral content” that is neither positive nor negative the reply represented by the query argument is categorized.

In addition, a query argument including an input value may be any data including a character, a character string, and a numerical value, and a query content represented by a query and a content of a reply from the server 900 represented by an answer may be any content. Thus, the query function may be, for example, a function that takes, as a query argument, a character string to be translated and returns, as a return value, an answer from the server 900 to a query querying a result of translation of the character string to be translated into a pre-specified language. Further, the query function may be a function that takes, as query arguments, a character string to be translated and information representing a language specified by the user and returns, as a return value, an answer from the server 900 to a query querying a result of translation of the character string to be translated into the language specified by the user.

### Modified Example 3 of Embodiment

In the embodiment, it is described that when the CPU 101 of the spreadsheet device 100 determines that an acquired event is an edit event, the CPU 101 performs the spreadsheet processing in FIG. 6. However, the CPU 101 may perform the spreadsheet processing and thereby perform calculation of a cell when the acquired event is determined to be at least one of (1) an edit event, (2) a delete event, (3) a calculation instructing operation event, (4) a save event, (5) an open event, or (6) a print event.

The edit event is an event in which a cell in the worksheet including the work cells 2A, 2B, and 3A or a cell in the cache sheet is edited, and the delete event is an event in which a row or a column in the worksheet or the cache sheet is deleted. The calculation instructing operation event is an event in which an operation to instruct calculation of a mathematical expression set in a cell is performed. The operation to instruct calculation includes, for example, (1) an operation to press an “F9” key and (2) an operation to press a “Shift” key and the “F9” key at the same time. The mathematical expression the calculation of which is instructed includes mathematical expressions that are set in all cells included in an active spreadsheet or included in all spreadsheets included in the book or cells included in a range selected by the user.

The save event is an event in which saving of the book is performed and is an event that occurs in a period from a timing a predetermined time earlier than a save timing that is a timing at which the saving of the book is started to the save timing. The open event is an event in which the book is opened and is an event that occurs in a period from an open timing that is a timing at which opening of the book is finished to a timing a predetermined time later than the open timing. The print event is an event in which at least one of the spreadsheets included in the book is printed and is an event that occurs in a period from a print timing that is a timing at which printing of at least one of the spreadsheets is started to a timing a predetermined time earlier than the print timing. Modified Example 4 of Embodiment

In the embodiment, the description is made using, as a specific example, a case where the character string “There is an opportunity to learn a skill” is input to the work cell 2A in FIG. 4 as a value and a mathematical expression referring to the input value in the work cell 2A is set in the work cell 2B. However, in the present modified example, the following description is made using, as a specific example, a case where the character string “There is an opportunity to learn a skill” is input to one or a plurality of work cells (referred to as one or a plurality of input value cells) including the work cell 2A, as a value. In addition, in the present modified example, the following description is made using, as a specific example, a case where a mathematical expression is set in a plurality of work cells (referred to as a plurality of mathematical expression cells) that is different from the one or a plurality of input value cells and that includes the work cell 2B and the mathematical expression is a mathematical expression that calls a query function referring to input values in the one or plurality of input value cells.

In addition, in the present modified example, the following description is made using, as a specific example, a case where the user who visually recognizes the character string “career-design” stored in a cache cell at the third row and the B-th column (referred to as a cache cell 3B) illustrated in FIG. 5 performs an operation to change the character string stored in the cache cell 3B to “benefits” on the input device 105c of the spreadsheet device 100. On this occasion, the CPU 101 of the spreadsheet device 100 edits the cache cell 3B, based on a signal output from the input device 105c. Subsequently, the CPU 101 acquires information representing an event and, when an acquired event represented by the acquired information is determined to be an edit event, performs the spreadsheet processing in FIG. 6 and the query processing in FIG. 7.

On this occasion, the inquirer 120 in the spreadsheet device 100 prevents execution of control to cause queries that are based on the input values in the one or plurality of input value cells to be transmitted to the server 900, by performing steps S20 and S19 in FIG. 7 in order. In addition, the inquirer 120 acquires an answer “benefits” after change stored in the cache cell 3B and outputs the acquired answer “benefits” after change. Subsequently, the calculator 110 stores the output answer “benefits” after change in a plurality of mathematical expression cells as a value by performing steps S06 and S07 in FIG. 6 in order.

According to the above-described configuration, when the spreadsheet device 100, after changing the answer “career-design” from the AI stored in the cache cell 3B to “benefits” in accordance with an operation by the user, performs recalculation on a plurality of mathematical expression cells, the spreadsheet device 100 stores the answer “benefits” after change stored in the cache cell 3B in the plurality of mathematical expression cells as a value. Therefore, when, for example, an answer from the AI and an answer that the user considers to be correct are different from each other, the user can change a value to be stored in a plurality of mathematical expression cells included in the worksheet to the answer that the user considers to be correct by changing an answer stored in the cache sheet, convenience for the user is improved.

### Modified Example 5 of Embodiment

In the embodiment, it is described that a character string representing a query content included in a query includes a character string representing a question. However, the character string expressing a query content is not limited to the configuration and may include not only (a) a character string representing a question but also (b) a character string relaxing a restriction imposed on an answer by the question. For this purpose, in step S14 in FIG. 7, the inquirer 120 in the spreadsheet device 100 may, after generating a structured text including a character string representing a query content, acquire a character string relaxing a restriction from, for example, the binary data representing the add-in program and add the acquired character string to the generated structured text.

In the embodiment, the description is made using, as a specific example, a case where a character string representing a question is a character string “Into which one of ‘salary’, ‘career-design’, and ‘benefits’ is a reply ‘There is an opportunity to learn a skill’ categorized?”. Thus, the restriction imposed on an answer by the question is a restriction that the answer has to be a character string representing that the reply “There is an opportunity to learn a skill” is categorized into one of the plurality of categories “salary”, “career-design”, and “benefits”.

Therefore, in the present modified example, the following description is made using, as a specific example, a case where the character string relaxing a restriction is a character string that (1) includes a character string representing that a reply to a questionnaire is not categorized into any of the plurality of categories (referred to as a non-categorization character string) and, (2) when the reply to the questionnaire is not categorized into any of the plurality of categories, relaxes the restriction imposed on the answer in such a way that the non-categorization character string is selected as an answer.

A reply not being categorized into any of the plurality of categories includes at least one of (1) the reply being unable or inappropriate to be categorized into one of the plurality of categories, (2) categorizing the reply into a category different from any of the plurality of categories being more appropriate than categorizing the reply into one of the plurality of categories, or (3) the categorization itself of the reply being unable or inappropriate to be performed. The reply that is unable or inappropriate to be categorized includes, for example, a reply that has no semantic relationship with any of the plurality of categories, and the reply that has no semantic relationship with any of the plurality of categories includes, for example, a reply “Nothing special.” and a reply “There is nothing special to say.”.

In addition, in the present modified example, the following description is made using, as a specific example, a case where the non-categorization character string is a character string “uncategorizable”. Thus, the following description is made using, as a specific example, a case where a character string relaxing a restriction is a character string “When categorization cannot be performed, please answer ‘uncategorizable’.”. However, the non-categorization character string is not limited to the examples and may be a character string “not-applicable” or “irrelevant” or a character string “no-category” or “uncategorized”. That is, the above-described character string relaxing a restriction relaxes a restriction that an answer has to be a character string representing that a reply to a questionnaire is categorized into one of the plurality of categories to a restriction that an answer has to be (1) one of the plurality of categories or (2) one of the character strings (a) “uncategorizable”, (b) “not-applicable”, (c) “irrelevant”, (d) “no-category”, and (e) “uncategorized”.

According to the above-described configuration, even when, for example, a user inexperienced in generation of a query sets a plurality of categories not including a non-categorization character string as query arguments, the spreadsheet device 100 is capable of relaxing a restriction imposed on an answer from a restriction that an answer has to be one of the plurality of categories to a restriction that an answer has to be one of the plurality of categories or the non-categorization character string. Therefore, when a reply is not categorized into any of a plurality of categories, the spreadsheet device 100 is capable of suppressing the AI in the server 900 from outputting an answer that the reply is categorized into one of the plurality of categories. Thus, the spreadsheet device 100 is capable of suppressing deterioration in precision of an answer that the query function outputs. Modified Example 6 of Embodiment

Although in Modified Example 5 of the embodiment, it is described that a character string representing a query content included in a query includes (a) a character string representing a question and (b) a character string relaxing a restriction imposed on an answer by the question, the present disclosure is not limited to the configuration. The character string representing the query content may include not only (a) a character string representing a question and (b) a character string relaxing a restriction imposed on an answer by the question but also (c) a character string representing a restriction imposed on an expression form of the answer (referred to as expression restriction character string). For this purpose, in step S14 in FIG. 7, the inquirer 120 in the spreadsheet device 100 may, after generating a structured text including a character string representing a query content and a character string relaxing a restriction, acquire an expression restriction character string from, for example, the binary data representing the add-in program and add the acquired character string to the generated structured text. In the present modified example, the following description is made using, as a specific example, a case where the expression restriction character string is a character string representing a restriction that an answer, instead of being expressed in a sentence or sentences, has to be expressed by a specified number of words, such as a character string “Please answer in a word.”. However, the expression restriction character string is not limited to the example and may be, for example, a character string “Please answer in just one word.” or a character string “Please answer in one noun.”.

In this case, when the acquired answer is one of the plurality of categories or the non-categorization character string, the inquirer 120 in the spreadsheet device 100 may determine that the answer does not violate the restriction and output the answer to the spreadsheet program. The reason why the answer is determined in this way is that in the present modified example, each of the plurality of categories and the non-categorization character string comply with the restriction represented by the expression restriction character string since each of the plurality of categories and the non-categorization character string are expressed in one word. In contrast, when the acquired answer is neither one of the plurality of categories nor the non-categorization character string, the inquirer 120 may determine that the answer violates a restriction after relaxation imposed by the question or a restriction on the expression form. When it is determined that the answer violates the restriction, the inquirer 120 may change the answer to the character string “uncategorizable” that is a non-categorization character string and store the answer after change in association with the query information, and also output the answer after change to the spreadsheet program as a return value.

According to the above-described configuration, the inquirer 120 in the spreadsheet device 100 is capable of restricting an expression form of an answer that the query function outputs as a return value, with high precision with a smaller amount of calculation than a case where when an acquired answer is expressed by, for example, a sentence or sentences, the inquirer 120 performs analysis including at least one of morphological analysis, syntax analysis, semantic analysis, or context analysis, changes the expression form of the answer, based on an analysis result, and outputs the changed answer. In addition, according to the above-described configuration, the spreadsheet device 100 is capable of restricting a return value that the query function outputs to one of the plurality of categories set by the user or the non-categorization character string, with a small amount of calculation with high precision.

Although in the present modified example, the description is made using, as an example, a case where the specified number of words is one, and the number of words in each of the plurality of categories and the non-categorization character string is one, the present disclosure is not limited to the configuration. The specified number of words and the number of words in each of the plurality of categories and the non-categorization character string may be a number of two or more. In addition, in the present modified example, a case where a character string representing a query content includes (a) a character string representing a question, (b) a character string representing a restriction imposed on an expression form of the answer, and (c) a character string relaxing a restriction imposed on an answer by the question is described. However, the character string representing a query content, although including (a) a character string representing a question and (b) a character string representing a restriction imposed on an expression form of the answer, does not have to include (c) a character string relaxing a restriction imposed on an answer by the question.

### Modified Example 7 of Embodiment

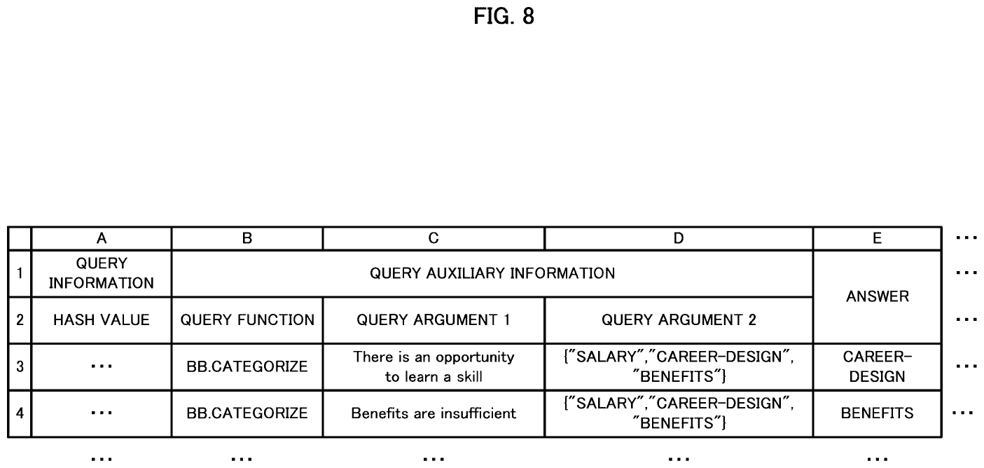

In the embodiment, it is described that the inquirer 120 in the spreadsheet device 100 stores query information and an answer in the cache sheet in association with each other. However, in the present modified example, the inquirer 120 stores query information, query auxiliary information, and an answer in the cache sheet in association with one another, as illustrated in FIG. 8. The query auxiliary information is information that assists identification of a query by the user of the spreadsheet device 100. In the present modified example, the query auxiliary information includes information representing a name of a query function and a query argument. Thus, in step S18 in FIG. 7, the inquirer 120 acquires a character string representing the name of the query function from, for example, the binary data representing the add-in program. In the present modified example, the following description is made using, as a specific example, a case where the name of the query function is “BB.CATEGORIZE”.

Next, the inquirer 120 in the spreadsheet device 100 inputs a hash value that is query information, as a value in a cache cell at the third row and the A-th column illustrated in FIG. 8. Subsequently, the inquirer 120 inputs a character string representing the name “BB. CATEGORIZE” of the query function, as a value in a cache cell at the third row and the B-th column. In addition, the inquirer 120 inputs a character string that is an input value in the work cell 2A and that represents a reply “There is an opportunity to learn a skill” to the questionnaire that is acquired as a query argument, as a value in a cache cell at the third row and the C-th column. Further, the inquirer 120 inputs a character string representing a plurality of categories “salary”, “career-design”, and “benefits” that is acquired as a query argument, as a value in a cache cell at the third row and the D-th column. In addition, the inquirer 120 inputs an answer “career-design” as a value in a cache cell at the third row and the E-th column. According to the above-described configuration, since the spreadsheet device 100 stores query auxiliary information and an answer in the cache sheet in association with each other, the user can easily conjecture or confirm a history of query contents to the server 900 by visually recognizing the cache sheet.

### Modified Example 8 of Embodiment

Although in the embodiment, it is described that a structured text includes a character string representing a query content to the server 900, a structured text according to the present modified example further includes an argument that is passed to the generative AI included in the server 900 (referred to as an AI argument). Although in the present modified example, the AI argument includes at least one of, for example, (1) a model specification argument, (2) a same expression suppression argument, (3) a general expression suppression argument, or (4) a randomness control argument, the AI argument is not limited thereto.

The model specification argument is an argument to specify a set of processing system including trained data that the generative AI in the server 900 uses. The set of processing system that the generative AI uses may further include a language model that the generative AI uses. In addition, the model specification argument may be, for example, an argument “model” used by ChatGPT, such as an argument to specify “GPT3.5” or “GPT4”. Further, the model specification argument may be an argument that is used to specify a set of processing system in Google Gemini (simply referred to as Gemini) or an argument that is used by a generative AI other than ChatGPT and Gemini.

The same expression suppression argument is an argument to suppress the same expression from being used in answers and may be, for example, an argument “frequency_penalty” that is used by ChatGPT. The general expression suppression argument is an argument to suppress a commonplace expression from being used in an answer and may be, for example, an argument “presence_penalty” that is used by ChatGPT. The randomness control argument is an argument to control randomness of an answer that the generative AI outputs and may be, for example, at least one of arguments “temperature” or “TOP_P” that are used by ChatGPT. In addition, at least one of the same expression suppression argument, the general expression suppression argument, or the randomness control argument may be an argument used by Gemini or an argument used by a generative AI other than ChatGPT and Gemini.

When the AI argument is included in, for example, a mathematical expression set in the work cell 2B, the inquirer 120 in the spreadsheet device 100 may acquire the AI argument in addition to an input value in the work cell 2A and a character string representing a plurality of categories, as query arguments in step S11 in FIG. 7. In addition, when no AI argument is included in the mathematical expression and no AI argument is acquired as a query argument, the inquirer 120 may acquire a predetermined default value of the AI argument from, for example, the binary data representing the add-in program and set the acquired default value in the AI argument. Subsequently, in step S14, the inquirer 120 generates a structured text including the AI argument, based on (1) (a) the input value in the work cell 2A and (b) the character string representing the plurality of categories that are acquired as query arguments and (2) the AI argument that is acquired as a query argument or the default value of which is set. Next, the inquirer 120 generates query information by calculating a hash value of the generated structured text.

Subsequently, when the inquirer 120 in the spreadsheet device 100 determines that no query information is stored in the cache sheet, the inquirer 120 generates a query including the AI argument in step S15 and performs control to cause the generated query to be transmitted to the server 900 in step S16. The generative AI in the server 900 generates an answer in accordance with the AI argument included in the query and returns the generated answer to the spreadsheet device 100. Modified Example 9 of Embodiment

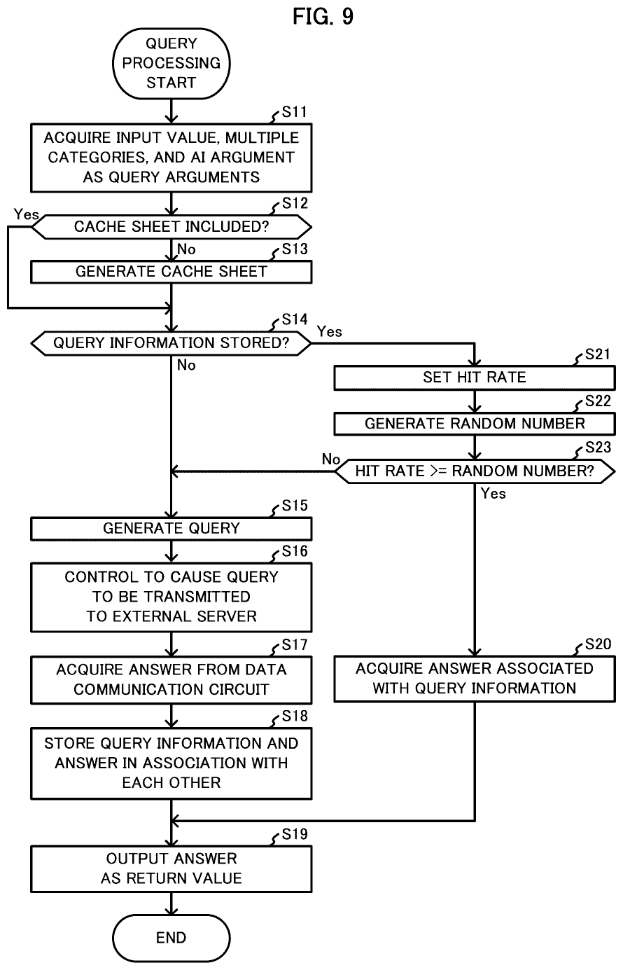

In the embodiment, it is described that when query information is saved in the cache sheet (referred to as a case of saved query information), the inquirer 120 in the spreadsheet device 100 acquires an answer from the cache sheet with a probability of 100% by performing the query processing in FIG. 7. However, in the present modified example, in the case of saved query information, the inquirer 120 acquires an answer from the cache sheet with a cache hit rate (simply referred to as a hit rate) that is set based on the randomness control argument, by performing query processing as illustrated in FIG. 9.

The hit rate is a probability with which the inquirer 120 in the spreadsheet device 100 acquires an answer from the cache sheet in the case of saved query information. In the present modified example, the following description is made using, as a specific example, a case where the randomness control argument is included in a mathematical expression to be set in the work cell 2B. Thus, when performance of the query processing illustrated in FIG. 9 is started, the inquirer 120 in the spreadsheet device 100 acquires (1) an input value in the work cell 2A that the work cell 2B refers to and (2) (a) a character string representing a plurality of categories and (b) the randomness control argument that are included in the mathematical expression in the work cell 2B, from the spreadsheet program as query arguments (step S11).

Next, after the inquirer 120 in the spreadsheet device 100 performs the processing in step S12 or the processing in steps S12 and S13 described in the embodiment, the inquirer 120 determines whether or not query information is stored in the cache sheet (step S14). On this occasion, when the inquirer 120 determines that no query information is stored in the cache sheet (step S14; No), the inquirer 120 performs processing in steps S15 to S19 and subsequently terminates the performance of the query processing. The processing in steps S15 to S19 performed when no query information is saved in the cache sheet (referred to as a case of unsaved query information) is the same processing as the processing described in the embodiment.

In contrast, when the inquirer 120 in the spreadsheet device 100 determines that query information is stored in the cache sheet (step S14; Yes), the inquirer 120 sets a hit rate, based on the randomness control argument acquired in step S11 (step S21). In the present modified example, since the randomness control argument is “temperature” used by ChatGPT, the following description is made using, as a specific example, a case where a value greater than or equal to a value of 0.0 at which the randomness is controlled to a lowest randomness and less than or equal to a value of 2.0 at which the randomness is controlled to a highest randomness is set in the randomness control argument “temperature”. Thus, the inquirer 120 sets the hit rate to a value calculated using, for example, the formula (1) below. That is, the inquirer 120, for example, sets the hit rate to a value of 100% when the randomness control argument “temperature” has a value of 0.0 and sets the hit rate to a value of 50% and a value of 0% when the randomness control argument “temperature” has a value of 1.0 and a value of 2.0, respectively. However, a setting method of the hit rate is not limited to the method using the formula (1) and may be any method as long as the higher the randomness control argument “temperature” controls the randomness of an answer generated by the generative AI, the lower the method sets the hit rate.

$$Hit rate = ( 1 - randomness control argument “ temperature ” / 2 ) \times 100 \% \qquad ( 1 )$$

Next, the inquirer 120 in the spreadsheet device 100 generates a software-generated random number having a value of 0 or more and 100 or less (step S22) and determines whether or not to acquire an answer from the cache sheet, based on the value of the generated software-generated random number and the value of the set hit rate. The value of the hit rate means a numerical value used in conjunction with a percent sign when the hit rate is represented using a percentage and, for example, means a value of 50 when the hit rate is 50%. On this occasion, when the inquirer 120 determines that the value of the software-generated random number is less than or equal to the value of the hit rate (step S23; Yes), the inquirer 120 determines to acquire an answer from the cache sheet. Subsequently, after the inquirer 120 acquires an answer associated with the query information from the cache sheet (step S20) and outputs the acquired answer to the spreadsheet program (step S19), the inquirer 120 terminates the performance of the query processing. In this way, the inquirer 120 acquires an answer from the cache sheet with the hit rate (also referred to as event probability) and outputs the acquired answer.

In contrast, when the inquirer 120 in the spreadsheet device 100 determines that the value of the software-generated random number is greater than the value of the hit rate (step S23; No), the inquirer 120 determines to acquire a new answer from the generative AI in the server 900. Next, the inquirer 120 generates a query including the randomness control argument serving as a basis to calculate a hit rate (referred to as a basic randomness control argument) (step S15) and performs control to cause the generated query to be transmitted to the server 900 on the data communication circuit 104a (step S16). Subsequently, the inquirer 120 acquires a new answer from the data communication circuit 104a (step S17) and overwrites the answer stored in the cache sheet in association with the query information with the acquired new answer (step S18). Subsequently, after the inquirer 120 outputs the new answer to the spreadsheet program (step S19), the inquirer 120 terminates the performance of the query processing. That is, the inquirer 120 acquires a new answer from the generative AI with a probability (referred to as complementary event probability) obtained by subtracting the event probability, which is the hit rate, from a probability of 100% and outputs the acquired answer.

According to the above-described configuration, in the case of saved query information, the inquirer 120 in the spreadsheet device 100 (1) prevents performance of control to cause a query to be transmitted to the server 900 and (2) outputs an answer acquired from the cache sheet to the spreadsheet program, with the event probability, which is the hit rate. In addition, in the case of saved query information, the inquirer 120 (1) performs control to cause a query to be transmitted to the server 900 and (2) outputs a new answer acquired from the server 900, with the complementary event probability. Thus, the inquirer 120 is capable of suppressing the randomness of an answer to be output from deteriorating while suppressing an increase in a communication volume between the spreadsheet device 100 and the server 900.

In addition, according to the above-described configuration, since the higher the randomness control argument controls the randomness, the lower the inquirer 120 in the spreadsheet device 100 sets the event probability, which is the hit rate, the inquirer 120 sets the complementary event probability higher. That is, the higher the randomness control argument controls the randomness, the lower the inquirer 120 sets probability with which the inquirer 120 acquires an answer without randomness from the cache sheet and the higher the inquirer 120 sets probability with which the inquirer 120 acquires a new answer with randomness from the server 900. Therefore, the inquirer 120 is capable of suppressing an increase in a difference between randomness of an answer output by the generative AI, the randomness being controlled by the randomness control argument, and randomness of an answer output by the inquirer 120.

### Modified Example 10 of Embodiment

Although in Modified Example 9 of the embodiment, it is described that the inquirer 120 in the spreadsheet device 100 acquires a randomness control argument included in a mathematical expression in the work cell 2B from the spreadsheet program as a query argument, the present disclosure is not limited to the configuration. The randomness control argument does not have to be included in a mathematical expression to be set in the work cell 2B. In this case, the inquirer 120 may, without acquiring the randomness control argument as a query argument, acquire a predetermined default value of the randomness control argument from, for example, the binary data representing the add-in program and set a hit rate, based on the acquired default value of the randomness control argument.

In addition, in a mathematical expression to be set in the work cell 2B, based on an operation performed by the user on the input device 105c of the spreadsheet device 100, the hit rate may be included instead of the randomness control argument. In this case, the inquirer 120 may, without acquiring the randomness control argument as a query argument and setting the hit rate, based on the randomness control argument, acquire the hit rate that is set based on an operation by the user, as a query argument. According to the above-described configuration, the user can set the hit rate to a probability with which a communication volume that the spreadsheet device 100 reduces is brought close to a volume desired by the user, only by operating the input device 105c of the spreadsheet device 100. In addition, according to the above-described configuration, the user can set the hit rate to a probability with which randomness of an answer that the inquirer 120 outputs is brought close to a randomness desired by the user, only by operating the input device 105c of the spreadsheet device 100. Because of this capability, convenience for the user is improved.

### Modified Example 11 of Embodiment

Although in Modified Example 9 of the embodiment, it is described that the randomness control argument is “temperature” used by ChatGPT, the randomness control argument may be “TOP_P”. In this case, in the randomness control argument “TOP_P”, a value that is greater than or equal to a value of 0.0 at which the randomness is controlled to a lowest randomness and less than or equal to a value of 1.0 at which the randomness is controlled to a highest randomness is set. Thus, the inquirer 120 in the spreadsheet device 100 sets the hit rate to a value calculated using, for example, the formula (2) below. However, a setting method of the hit rate is not limited to the method using the formula (2) and may be any method as long as the higher the randomness control argument “TOP_P” controls the randomness, the lower the method sets the hit rate. In addition, the randomness control argument used for setting of the hit rate is not limited to an AI argument used by ChatGPT and may be an AI argument that is used to control randomness by Gemini or an argument that is used by a generative AI other than ChatGPT and Gemini.

$$Hit rate = ( 1 - randomness control argument “ TOP\_P ” ) \times 100 \% \qquad ( 2 )$$

### Modified Example 12 of Embodiment

In Modified Example 9 of the embodiment, it is described that when query information is saved in the cache sheet (that is, in the case of saved query information), the inquirer 120 in the spreadsheet device 100 performs control to cause a query including a randomness control argument serving as a basis to calculate a hit rate (that is, a basic randomness control argument) to be transmitted, with complementary event probability. However, in the present modified example, the inquirer 120 corrects the basic randomness control argument into an argument that controls randomness in such a way that a value of the randomness is higher than that in a case where the randomness is controlled by the basic randomness control argument. Next, the inquirer 120 performs control to cause the query including a randomness control argument after correction to be transmitted to the server 900 on the data communication circuit 104a.

In the present modified example, the inquirer 120 in the spreadsheet device 100, for example, corrects the basic randomness control argument “temperature” in such a way that a randomness control argument “temperature” after correction has a value of 2.0 at which the randomness is controlled to a highest randomness. The reason why such correction is performed is to suppress deterioration in randomness of an answer that is generated by acquiring the answer from the cache sheet. The reason why randomness of an answer is lost is described using, as a specific example, a case where the generative AI is controlled in such a way that the randomness of an answer to be generated is 50% by the randomness control argument “temperature” having a value of 1.0 and the generative AI is controlled in such a way that the randomness is 100% by the randomness control argument “temperature” having a value of 2.0. In this case, when no answer is acquired from the cache sheet and a query including the basic randomness control argument “temperature” having a value of 1.0 is transmitted to the server 900 with a probability of 100% (referred to as a case where a randomness control argument having a value of 1.0 is used with a probability of 100%), an answer having a randomness of 50% is acquired from the generative AI in the server 900 with a probability of 100%.

In contrast, when the hit rate (that is, event probability) is set to 50%, based on the randomness control argument “temperature” having a value of 1.0, an answer having a randomness of 0% is acquired from the cache sheet with an event probability of 50%, as described in Modified Example 9 of the embodiment. On this occasion, when a query including the basic randomness control argument “temperature” having a value of 1.0 is transmitted to the server 900 with a complementary event probability of 50%, an answer having a randomness of 50% is merely acquired with a complementary event probability of 50%. Since when the randomness control argument having a value of 1.0 is used with a probability of 50% and an answer is acquired from the cache sheet with a probability of 50% in this way, the randomness of an answer to be acquired is 25%, the randomness deteriorates by 25% compared with the randomness of 50% in the case where the randomness control argument having a value of 1.0 is used with a probability of 100%.

In contrast, in the present modified example, control to cause a new query including the randomness control argument “temperature” the value of which is corrected to a value of 2.0, which is higher than a value of 1.0 of the basic randomness control argument “temperature”, to be transmitted is performed with a complementary event probability of 50%. Thus, an answer having a randomness of 100% is acquired with a complementary event probability of 50%. That is, in the present modified example, since even when an answer is acquired from the cache sheet with a probability of 50%, the randomness control argument having a value of 2.0 is used with a probability of 50%, the randomness of an answer to be acquired is equal to a randomness of 50% of an answer that is acquired when the randomness control argument having a value of 1.0 is used with a probability of 100%.

Although in the present modified example, it is described that the basic randomness control argument “temperature” is corrected in such a way that the randomness control argument “temperature” after correction has a value of 2.0, the correction method is not limited to this method. The correction method of the basic randomness control argument may be any method as long as the method is a correction method that makes the value of the randomness control argument after correction larger than the value of the basic randomness control argument. In addition, in the present modified example, the reason why randomness of an answer is lost is described using, as a specific example, a case where the generative AI is controlled by the randomness control argument “temperature” having a value of 1.0 in such a way that the randomness of an answer to be generated is 50% and the generative AI is controlled by the randomness control argument “temperature” having a value of 2.0 in such a way that the randomness is 100%. However, a relationship between the value of the randomness control argument included in a query and the randomness of an answer to the query is not limited to this relationship and may be any relationship as long as there is a correlation between the value of the randomness control argument and the randomness of an answer.

According to the above-described configuration, the inquirer 120 in the spreadsheet device 100 corrects a basic randomness control argument into an argument that controls randomness in such a way that the value of the randomness is higher than that in a case where the randomness is controlled by the basic randomness control argument. In addition, the inquirer 120 (1) causes the data communication circuit 104a in FIG. 2 to transmit a new query including the randomness control argument after correction to the server 900 and subsequently (2) outputs a new answer acquired from the generative AI in the server 900, with the complementary event probability. Further, the inquirer 120 outputs an answer acquired from the cache sheet with the event probability. Because of this configuration, the inquirer 120 is capable of suppressing the randomness of an answer to be output from deteriorating while suppressing an increase in a communication volume between the spreadsheet device 100 and the server 900.

### Modified Example 13 of Embodiment

Although in the embodiment, it is described that the server 900 is equipped with a generative AI that is ChatGPT, the generative AI is not limited to ChatGPT. The generative AI may be Gemini or an AI other than ChatGPT and Gemini. In addition, although in the embodiment, the description is made assuming that the spreadsheet program is Excel, the present disclosure is not limited to the configuration. The spreadsheet program may be Google Spreadsheet, WPS Office Spreadsheet, or Numbers or may be a program other than the foregoing programs. In addition, although in the embodiment, it is described that the CPU 101 of the spreadsheet device 100 functions as the inquirer 120 by executing an add-in program added to the spreadsheet program itself, the CPU 101 may function as the inquirer 120 by executing the spreadsheet program itself.

Further, although in the embodiment, the inquirer 120 in the spreadsheet device 100 generates one cache sheet in a book, the inquirer 120 may generate two or more cache sheets. In addition, although in the embodiment, it is described that while a cache name character string is included in the name of the cache sheet, no cache name character string is included in the name of a worksheet, the present disclosure is not limited to the configuration. For example, while the cache name character string is input to a type input cell in the cache sheet as a value, the cache name character string does not have to be input to a type input cell in the worksheet as a value. The type input cell means a cell that is defined in advance as a cell to which a character string representing a type of the spreadsheet is input. In addition, the type input cell may be, for example, a cell in a predetermined row and a predetermined column or a cell for which a name indicating that the cell is a type input cell is defined. In this case, the inquirer 120 may acquire values input to type input cells from all spreadsheets included in the book and, when a value that is a cache name character string exists among the acquired values, determine that the book includes a cache sheet and, when no such a value exists, determine that the book does not include a cache sheet.

Although it is described that a book that the spreadsheet device 100 opens includes one worksheet, the book may include a plurality of worksheets, and the spreadsheet device 100 may, after opening the book including one worksheet, add one or more worksheets to the opened book. In addition, the spreadsheet device 100 may generate a book including one or more worksheets or add one or more worksheets to the generated book. In addition, although in the embodiment, it is described that the spreadsheet device 100 opens a book including no cache sheet, the spreadsheet device 100 may open a book including a cache sheet. Further, the spreadsheet device 100 may generate a book including no cache sheet or generate a book including a cache sheet.

Further, in the embodiment, it is described that a query function called by a mathematical expression set in the work cell 2B refers to an input value in the work cell 2A and a worksheet including the work cell 2A (referred to as a worksheet A) and a worksheet including the work cell 2B (referred to as a worksheet B) are the same worksheet. However, the worksheet A and the worksheet B may be different sheets. In addition, a book including the worksheet A (referred to as a book A) and a book including the worksheet B (referred to as a book B) may be the same book or different books. In addition, when the book A and the book B are different books, the inquirer 120 in the spreadsheet device 100 may generate a cache sheet in the book B and store query information used in calculation of the worksheet B in the generated cache sheet. Further, although in the embodiment, it is described that the query function of the work cell 2B takes an input value in the work cell 2A as a query argument, the query function of the work cell 2B may take a value included in a mathematical expression set in the work cell 2B as a query argument.

In addition, in the embodiment, it is described that in the work cell 2B, a mathematical expression that returns a return value of the query function as a calculation result is set. However, in the work cell 2B, a mathematical expression that returns a result of application of some processing to a return value of the query function as a calculation result may be set. The some processing may include at least one of, for example, processing of adding a predetermined character or character string to a return value, processing of deleting a predetermined character or character string from a return value, or processing of converting a predetermined character or character string included in a return value to a character or a character string different from the predetermined character or character string.

In addition, although in the embodiment, it is described that the work cells 2B and 3A are edited in order, order in which work cells are edited may be any type of order. In addition, although in the embodiment, it is described that the work cells 2A, 2B, and 3A and a cell different from the foregoing cells are selected as a processing target in order, order in which cells are selected as a processing target may be any type of order.

In the embodiment, it is described that in step S04 in FIG. 6, a mathematical expression in the work cell 2B is determined to call a query function. However, when the mathematical expression in the work cell 2B is determined not to call a query function (step S04; No), the calculator 110 in the spreadsheet device 100 may calculate the mathematical expression in the work cell 2B without using a query function (step S08) and store a calculation result in the cell as a value of the work cell 2B (step S07).

In the embodiment, it is described that the calculator 110 in the spreadsheet device 100 saves each of a worksheet and a cache sheet in the same electronic file by saving a book. However, the inquirer 120 may save each of a worksheet and a cache sheet in the same electronic file by saving a book. Timing at which the inquirer 120 saves the book may include at least one of a timing at which a cache sheet is generated in the book, a timing at which query information is stored in the cache sheet, or a timing at which an answer is output to the spreadsheet program as a return value.

In the embodiment, it is described that when query information representing a query and an answer from the server 900 to the query are not saved in the cache sheet in association with each other, the inquirer 120 in the spreadsheet device 100 causes the data communication circuit 104a to transmit the query to the server 900, acquires an answer from the server 900 from the data communication circuit 104a, and saves the query information and the answer in the cache sheet in association with each other. However, when a query and an answer are not saved in the cache sheet in association with each other, the inquirer 120 may cause the data communication circuit 104a to transmit the query to the server 900, acquire an answer from the server 900 from the data communication circuit 104a, and save the query and the answer in the cache sheet in association with each other. In this case, when a query and an answer are saved in the cache sheet in association with each other, the inquirer 120 may prevent causing the data communication circuit 104a to transmit the query to the server 900 and acquire an answer associated with the query from the cache sheet.

Although in the embodiment, the description is made using, as a specific example, a case where a worksheet and a cache sheet are spreadsheets different from each other, the worksheet and the cache sheet may be the same spreadsheet as each other.

Although in the embodiment, it is described that query information is a hash value of text data included in a query, the present disclosure is not limited to the configuration. The query information may be a hash value of the query or the same information as query auxiliary information. Although in Modified Example 7 of the embodiment, it is described that the query auxiliary information includes information representing a name of a query function and a query argument, the present disclosure is not limited to the configuration. The query auxiliary information may include a query argument but does not have to include information representing a name of a query function.

The embodiment and Modified Examples 1 to 13 of the embodiment can be combined with one another. The present disclosure can be provided as not only the spreadsheet device 100 including a configuration to achieve functions according to one of the embodiment and Modified Examples 1 to 13 of the embodiment but also a system that is a system including a plurality of devices and that includes, as an entire system, a configuration to achieve functions according to one of the embodiment and Modified Examples 1 to 13 of the embodiment. In addition, a distribution method of a spreadsheet program and an add-in program for the spreadsheet program according to one of the embodiment and Modified Examples 1 to 13 of the embodiment can be arbitrarily chosen, and it is possible to distribute the spreadsheet program and the add-in program not only by storing the spreadsheet program and the add-in program in a non-transitory recording medium, such as a memory card, a compact disc (CD)-ROM, and a digital versatile disk (DVD)-ROM, but also via a communication medium, such as the Internet. In addition, a method according to the present disclosure can be embodied using the spreadsheet system 1 or the spreadsheet device 100 according to one of the embodiment and Modified Examples 1 to 13 of the embodiment.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### APPENDICES

### Appendix 1

A spreadsheet device to process a worksheet and a cache sheet, the spreadsheet device characterized by performing a process comprising:
(1) in a case where in a cell in the worksheet, a mathematical expression that calls a query function referring to an input value having been input to another cell in the worksheet is set:
   (a) generating a query that is based on the input value;
   (b) transmitting the query to an external server;
   (c) acquiring an answer from the external server;
   (d) storing query information representing the query and the answer in the cache sheet in association with each other; and
   (e) storing the acquired answer as a value of the cell; and
(2) in a case where the query information representing the query is stored in the cache sheet when recalculation is performed on the cell,
   acquiring the answer that is stored in the cache sheet in association with the query information, as a value to be stored in the cell in place of transmitting the query to the external server and acquiring the answer.

### Appendix 2

The spreadsheet device according to appendix 1, characterized in that the spreadsheet device performs the recalculation on the cell at least one of (1) when a first cell that is the cell, a second cell that is the another cell, or a third cell that is different from the first cell and the second cell is edited, (2) when a row or a column that includes the third cell is deleted, (3) when an operation to instruct calculation is performed, (4) when a workbook including the worksheet is saved, (5) when the workbook is opened, or (6) when at least one of the worksheet or the cache sheet is printed.

### Appendix 3

The spreadsheet device according to appendix 1 or 2, characterized in that
the query includes (1) a query querying into which one of a plurality of categories the input value is categorized or (2) a query querying a result of translation of the input value into a specified language, and
the spreadsheet device transmits the query to the external server that is equipped with a generative artificial intelligence (AI).

### Appendix 4

A spreadsheet method performed by a spreadsheet device to process a worksheet and a cache sheet, the spreadsheet method characterized by comprising:
(1) in a case where in a cell in the worksheet, a mathematical expression that calls a query function referring to an input value having been input to another cell in the worksheet is set:
   (a) generating a query that is based on the input value;
   (b) transmitting the query to an external server;
   (c) acquiring an answer from the external server;
   (d) storing query information representing the query and the answer in the cache sheet in association with each other; and
   (e) storing the acquired answer as a value of the cell; and
(2) in a case where the query information representing the query is stored in the cache sheet when recalculation is performed on the cell,
   acquiring the answer that is stored in the cache sheet in association with the query information, as a value to be stored in the cell in place of transmitting the query to the external server and acquiring the answer.

### Appendix 5

A spreadsheet program characterized by causing a computer of a spreadsheet device including a communicator and configured to process a worksheet and a cache sheet to function as a spreadsheet calculator, the spreadsheet calculator performing a process comprising:
(1) in a case where in a cell in the worksheet, a mathematical expression that calls a query function referring to an input value having been input to another cell in the worksheet is set:
   (a) generating a query that is based on the input value;
   (b) causing the communicator to transmit the query to an external server;
   (c) acquiring an answer from the external server from the communicator;
   (d) storing query information representing the query and the answer in the cache sheet in association with each other; and
   (e) storing the acquired answer as a value of the cell; and
(2) in a case where the query information representing the query is stored in the cache sheet when recalculation is performed on the cell,
   acquiring the answer that is stored in the cache sheet in association with the query information, as a value to be stored in the cell in place of causing the communicator to transmit the query to the external server and acquiring the answer.

### Appendix 6

An add-in program for a spreadsheet program, the add-in program being characterized by causing a computer of a spreadsheet device including a communicator and configured to process a worksheet and a cache sheet to function as an inquirer, the inquirer performing a process comprising:
(1) in a case where in a cell in the worksheet, a mathematical expression that calls a query function referring to an input value having been input to another cell in the worksheet is set:
   (a) generating a query that is based on the input value;
   (b) causing the communicator to transmit the query to an external server;
   (c) acquiring an answer from the external server from the communicator;
   (d) storing query information representing the query and the answer in the cache sheet in association with each other; and
   (e) outputting the acquired answer as a value of the cell; and
(2) in a case where the query information representing the query is stored in the cache sheet when recalculation is performed on the cell,
   acquiring the answer that is stored in the cache sheet in association with the query information, as a value to be stored in the cell in place of causing the communicator to transmit the query to the external server and acquiring the answer.

### Appendix 7

The add-in program according to appendix 6, characterized in that when the cache sheet does not exist, the inquirer generates the cache sheet in a workbook including the worksheet and stores the query information and the answer in the generated cache sheet.

### Appendix 8

The add-in program according to appendix 6 or 7, characterized in that each of the worksheet and the cache sheet is saved in a same electronic file.

### Appendix 9

The add-in program according to any one of appendices 6 to 8, characterized in that
the external server is equipped with a generative artificial intelligence (AI),
in the query, a randomness control argument that is an argument to control randomness of the answer that the generative AI generates is included, and
the inquirer, when the query information is stored in the cache sheet,
(1) acquires the answer that is stored in the cache sheet in association with the query information, with a cache hit rate that is set based on the randomness control argument or is set based on an operation performed on an inputter included in the spreadsheet device, and
(2) causes the communicator to transmit a new query that is based on the input value to the external server with a probability obtained by subtracting the cache hit rate from a probability of 100% and acquires a new answer from the external server from the communicator.

### Appendix 10

An add-in program characterized by causing a computer of a spreadsheet device including a communicator and configured to execute a spreadsheet program to function as an inquirer, the inquirer performing a process comprising
in a case of a saved state in which a query based on a query argument acquired from the spreadsheet program or query information representing the query and an answer from a server to the query are saved in a spreadsheet in association with each other:
(1) preventing causing the communicator to transmit the query to the server;
(2) acquiring the answer associated with the query or the query information from the spreadsheet; and
(3) outputting the acquired answer as a return value to the spreadsheet program.

### Appendix 11

The add-in program according to any one of appendices 6 to 10, characterized in that
the server is equipped with a generative artificial intelligence (AI),
in the query, an AI argument that is an argument of the generative AI is included,
in the AI argument, a randomness control argument that is an argument to control randomness of the answer that the generative AI generates is included, and
the inquirer
(1) sets, based on the randomness control argument or based on an operation performed on an inputter included in the spreadsheet device, a cache hit rate that is a probability with which the answer associated with the query or the query information is acquired from the spreadsheet in a case of the saved state, and
(2) in a case of the saved state, at the cache hit rate that is set,
   (a) prevents causing the communicator to transmit the query to the server,
   (b) acquires the answer associated with the query or the query information from the spreadsheet, and
   (c) outputs the acquired answer as the return value.

### Appendix 12

The add-in program according to any one of appendices 6 to 11, characterized in that the inquirer sets as the higher the randomness control argument controls the randomness, the lower the cache hit rate.

### Appendix 13

The add-in program according to any one of appendices 6 to 12, characterized in that
the inquirer, in a case of the saved state, at a complementary event probability that is a probability obtained by subtracting the cache hit rate from a probability of 100%,
(1) causes the communicator to transmit, to the server, a new query that is based on the query argument,
(2) acquires, from the communicator, a new answer from the server, and
(3) outputs the acquired new answer as the return value.

### Appendix 14

The add-in program according to any one of appendices 6 to 13, characterized in that
the inquirer causes the communicator to transmit, in a case of the saved state, at the complementary event probability, the new query including a randomness control argument to control the randomness in such a way that a value of the randomness is higher than that in a case where the randomness is controlled by the randomness control argument serving as a basis to set the cache hit rate.

### Appendix 15

The add-in program according to any one of appendices 6 to 14, characterized in that
the query argument includes a plurality of categories and a categorization target character string that is a target of categorization,
the query includes a character string representing a question that which one of the plurality of categories the categorization target character string is categorized, and a character string relaxing a restriction imposed on the answer by the question, and
the communicator is caused to transmit the query to the server equipped with the generative AI.

### Appendix 16

The add-in program according to any one of appendices 6 to 15, characterized in that
the restriction imposed on the answer by the question includes a restriction that the answer has to be one of the plurality of categories, and
the character string relaxing the restriction relaxes the restriction imposed on the answer by the question to a restriction that the answer has to be one of the plurality of categories or a non-categorization character string, the non-categorization character string representing that the categorization target character string is not categorized into any of the plurality of categories.

### Appendix 17

The add-in program according to any one of appendices 6 to 16, characterized in that
the generative AI is an interactive AI,
the query further includes a character string representing a restriction imposed on an expression form of the answer,
an expression form of each of the plurality of categories and an expression form of the non-categorization character string comply with the restriction imposed on the expression form, and
in a case where the answer is neither the non-categorization character string nor any of the plurality of categories, the inquirer changes the answer to the non-categorization character string and outputs the changed answer as the return value.

### Appendix 18

The add-in program according to any one of appendices 6 to 17, characterized in that
the restriction imposed on the expression form of the answer is a restriction that the answer has to be expressed by a predetermined number of words.

### Appendix 19

The add-in program according to any one of appendices 6 to 18, characterized in that
the inquirer, in a case of a unsaved state in which the query or the query information and the answer are not saved in the spreadsheet in association with each other,
(1) causes the communicator to transmit the query to the server,
(2) acquires, from the communicator, the answer from the server,
(3) outputs the acquired answer as the return value, and
(4) saves the query or the query information and the answer in the spreadsheet in association with each other.

### Appendix 20

The spreadsheet device according to any one of appendices 1 to 3, characterized in that
in a case where the mathematical expression is set in a plurality of cells in the worksheet and the answer stored in the cache sheet is changed, an answer after change stored in the cache sheet is stored in the plurality of cells as a value in place of transmitting the query to the external server and acquiring the answer when recalculation is performed on the plurality of cells, the plurality of cells including the cell.

### REFERENCE SIGNS LIST

1 Spreadsheet system
100 Spreadsheet device
101 CPU
102 RAM
103a ROM
103b Storage device
104a Data communication circuit
105a Video card
105b Display device
105c Input device
110 Calculator
120 Inquirer
130 Spreadsheet calculator
190 Information storage
900 Server
NT Network

1. A spreadsheet device, comprising:
at least one memory storing program code;
at least one processor operable to read the program code and operate as instructed by the program code; and
a communication circuit caused by the at least one processor to transmit information,
the program code being configured to cause the at least one processor to process a worksheet and a cache sheet, the program code causing the at least one processor to
in a case where in a cell in the worksheet, a mathematical expression that calls a query function configured to refer to an input value having been input to another cell in the worksheet is set:
generate a query that is based on the input value;
control the communication circuit to transmit the query to an external server;
acquire from the communication circuit an answer from the external server;
store query information representing the query and the answer in the cache sheet in association with each other; and
store the acquired answer as a value of the cell; and
in a case where the query information representing the query is stored in the cache sheet when the at least one processor is caused to perform recalculation on the cell,
acquire the answer that is stored in the cache sheet in association with the query information, as a value to be stored in the cell in place of causing the communication circuit to transmit the query to the external server and acquiring the answer from the communication circuit.

2. The spreadsheet device according to claim 1, wherein the program code is configured to cause the at least one processor to perform the recalculation on the cell at least one of when a first cell that is the cell, a second cell that is the another cell, or a third cell that is different from the first cell and the second cell is edited, when a row or a column that includes the third cell is deleted, when an operation to instruct calculation is performed, when a workbook including the worksheet is saved, when the workbook is opened, or when at least one of the worksheet or the cache sheet is printed.

3. The spreadsheet device according to claim 1, wherein
the query includes a query querying into which one of a plurality of categories the input value is categorized or a query querying a result of translation of the input value into a specified language, and
the communication circuit is configured to transmit the query to the external server that is equipped with a generative artificial intelligence (AI).

4. A spreadsheet method performed by a spreadsheet device to process a worksheet and a cache sheet, the spreadsheet method comprising:
in a case where in a cell in the worksheet, a mathematical expression that calls a query function referring to an input value having been input to another cell in the worksheet is set:
generating a query that is based on the input value;
transmitting the query to an external server;
acquiring an answer from the external server;
storing query information representing the query and the answer in the cache sheet in association with each other; and
storing the acquired answer as a value of the cell; and
in a case where the query information representing the query is stored in the cache sheet when recalculation is performed on the cell,
acquiring the answer that is stored in the cache sheet in association with the query information, as a value to be stored in the cell in place of transmitting the query to the external server and acquiring the answer.

5. A non-transitory computer-readable recording medium storing a spreadsheet program, the spreadsheet program configured to cause a computer of a spreadsheet device including a communication circuit and configured to process a worksheet and a cache sheet to function as a spreadsheet calculator, the spreadsheet calculator performing a process comprising:
in a case where in a cell in the worksheet, a mathematical expression that calls a query function referring to an input value having been input to another cell in the worksheet is set:
generating a query that is based on the input value;
causing the communication circuit to transmit the query to an external server;
acquiring an answer from the external server from the communication circuit;
storing query information representing the query and the answer in the cache sheet in association with each other; and
storing the acquired answer as a value of the cell; and
in a case where the query information representing the query is stored in the cache sheet when recalculation is performed on the cell,
acquiring the answer that is stored in the cache sheet in association with the query information, as a value to be stored in the cell in place of causing the communication circuit to transmit the query to the external server and acquiring the answer.

6. A non-transitory computer-readable recording medium storing an add-in program for a spreadsheet program, the add-in program configured to cause a computer of a spreadsheet device including a communication circuit and configured to process a worksheet and a cache sheet to function as an inquirer, the inquirer performing a process comprising:
in a case where in a cell in the worksheet, a mathematical expression that calls a query function referring to an input value having been input to another cell in the worksheet is set:
generating a query that is based on the input value;
causing the communication circuit to transmit the query to an external server;
acquiring an answer from the external server from the communication circuit;
storing query information representing the query and the answer in the cache sheet in association with each other; and
outputting the acquired answer as a value of the cell; and
in a case where the query information representing the query is stored in the cache sheet when recalculation is performed on the cell,
acquiring the answer that is stored in the cache sheet in association with the query information, as a value to be stored in the cell in place of causing the communication circuit to transmit the query to the external server and acquiring the answer.

7. The non-transitory computer-readable recording medium according to claim 6, wherein when the cache sheet does not exist, the inquirer generates the cache sheet in a workbook including the worksheet and stores the query information and the answer in the generated cache sheet.

8. The non-transitory computer-readable recording medium according to claim 6, wherein each of the worksheet and the cache sheet is saved in a same electronic file.

9. The non-transitory computer-readable recording medium according to claim 6, wherein
the external server is equipped with a generative artificial intelligence (AI),
in the query, a randomness control argument that is an argument to control randomness of the answer that the generative AI generates is included, and
the inquirer, when the query information is stored in the cache sheet,
acquires the answer that is stored in the cache sheet in association with the query information, with a cache hit rate that is set based on the randomness control argument or is set based on an operation performed on an inputter included in the spreadsheet device, and
causes the communication circuit to transmit a new query that is based on the input value to the external server with a probability obtained by subtracting the cache hit rate from a probability of 100% and acquires a new answer from the external server from the communication circuit.

10. A non-transitory computer-readable recording medium storing an add-in program, the add-in program configured to cause a computer of a spreadsheet device including a communication circuit and configured to process a spreadsheet by executing a spreadsheet program to function as an inquirer, the inquirer performing a process comprising
in a case of a saved state in which a query based on a query argument acquired from the spreadsheet program or query information representing the query and an answer from a server to the query are saved in the spreadsheet in association with each other:
preventing causing the communication circuit to transmit the query to the server;
acquiring the answer associated with the query or the query information from the spreadsheet; and
outputting the acquired answer as a return value to the spreadsheet program.

11. The non-transitory computer-readable recording medium according to claim 10, wherein
every time receiving the query argument from the spreadsheet program after the spreadsheet device changes, in accordance with a user operation, the answer saved in the spreadsheet, the inquirer
prevents the communication circuit from transmitting the query to the server,
acquires the changed answer associated with the query or the query information from the spreadsheet, and
outputs the acquired changed answer as a return value to the spreadsheet program.

12. The spreadsheet device according to claim 2, wherein
the query includes a query querying into which one of a plurality of categories the input value is categorized or a query querying a result of translation of the input value into a specified language, and
the communication circuit is configured to transmit the query to the external server that is equipped with a generative artificial intelligence (AI).

13. The non-transitory computer-readable recording medium according to claim 7, wherein each of the worksheet and the cache sheet is saved in a same electronic file.

14. The non-transitory computer-readable recording medium according to claim 7, wherein
the external server is equipped with a generative artificial intelligence (AI),
in the query, a randomness control argument that is an argument to control randomness of the answer that the generative AI generates is included, and
the inquirer, when the query information is stored in the cache sheet,
acquires the answer that is stored in the cache sheet in association with the query information, with a cache hit rate that is set based on the randomness control argument or is set based on an operation performed on an inputter included in the spreadsheet device, and
causes the communication circuit to transmit a new query that is based on the input value to the external server with a probability obtained by subtracting the cache hit rate from a probability of 100% and acquires a new answer from the external server from the communication circuit.

15. The non-transitory computer-readable recording medium according to claim 8, wherein
the external server is equipped with a generative artificial intelligence (AI),
in the query, a randomness control argument that is an argument to control randomness of the answer that the generative AI generates is included, and
the inquirer, when the query information is stored in the cache sheet,
acquires the answer that is stored in the cache sheet in association with the query information, with a cache hit rate that is set based on the randomness control argument or is set based on an operation performed on an inputter included in the spreadsheet device, and
causes the communication circuit to transmit a new query that is based on the input value to the external server with a probability obtained by subtracting the cache hit rate from a probability of 100% and acquires a new answer from the external server from the communication circuit.
